(19) United States
(12) Patent Application Publication
(10) Pub. No.: US 2006/0116123 A1
(43) Pub. Date: Jun. 1, 2006

(54) Method and apparatus to optimize paging in a flexible multi-carrier system

(75) Inventors: Rene Purnadi, Coppell, TX (US); Haihong Zheng, Coppell, TX (US); Naveen Kakani, Irving, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/999,440

(22) Filed: Nov. 29, 2004

(51) Int. Cl. H04Q 7/20

(52) U.S. Cl. 455/435.1

(57) ABSTRACT

The invention provides in one aspect thereof a multi-carrier (MC) wireless network with a method to allocate a carrier to an idle mobile station. The method includes, responsive to the mobile station registering with the MC wireless network, selecting one of N available carriers to be assigned to the idle mobile station based on at least one criterion, and subsequently paging the idle mobile station on the assigned one of the N available carriers. The invention further provides, in other aspects thereof, a MC wireless network that operates in accordance with the methods, and a mobile station having a transceiver and a controller that is operable with the MC wireless network, where the controller is responsive to an order message received from the MC wireless network via the transceiver, when in an idle state, to transition to a carrier identified by the order message and to monitor the paging message in the assigned carrier. The controller further executes an idle handoff to one of another carrier, in a target cell, identified by a subsequent order message received over the assigned carrier, or to the same carrier in the target cell.

### TECHNICAL FIELD

The presently preferred embodiments of this invention relate generally to wireless communications systems and, more specifically, relate to radio frequency (RF) communications systems employing a plurality of RF carriers (a multi-carrier system) such as, but not limited to, a proposed multi-carrier code division multiple access (CDMA) system that is currently known generally as cdma2000 3× EV-DV, also referred to as cdma2000 Multi-Carrier (MC), and variations thereof.

### BACKGROUND

As currently specified, the cdma2000 MC system evenly distributes downlink traffic (traffic going from a base station (BS) to a mobile station (MS)) to all of the forward link carriers (to the three specified 1.25 MHz carriers). As currently specified, the MS maybe assigned one carrier or three carriers to receive data, depending on the required Quality of Service (QoS).

In the currently specified wireless system standards, for both the single carrier (1× EV-DV) and three carrier (3× EV-DV) systems, after selecting a serving system the MS should acquire the system with a center frequency indicated in a CDMA channel number specified in a preferred list. The MS then “parks” on that carrier (i.e., remains tuned to that carrier) and monitors the paging channel. It is via the paging channel that the system informs the MS of an incoming call. Stated another way, when the MS is idle (not receiving or transmitting any data), the MS is to park in a designated carrier with the center frequency indicated by a CDMA channel number in the MS preferred list, more specifically the preferred CDMA channel numbers (CDMACHs) for the selected preferred CDMA serving system (SERVSYS). Therefore, all idle MSs park in the same carrier, and the existing standards do not discuss the possibility of an idle MS parking in a different carrier, and how to page such as a MS. The current standard also does not discuss an ability to move an idle MS from one carrier to another carrier.

### SUMMARY OF THE PREFERRED EMBODIMENTS

The foregoing and other problems are overcome, and other advantages are realized, in accordance with the presently preferred embodiments of this invention.

In one aspect thereof this invention provides a MC wireless network with a method to allocate a carrier to an idle mobile station. The method includes, responsive to the mobile station registering with the MC wireless network, selecting one of N available carriers to be assigned to the idle mobile station based on at least one criterion, and subsequently paging the idle mobile station on the assigned one of the N available carriers.

In another aspect thereof this invention provides a MC wireless network that includes a carrier allocation function to allocate a carrier to an idle mobile station. The carrier allocation function includes a carrier selector, responsive to the mobile station registering with the MC wireless network, to select one of N available carriers to be assigned to the idle mobile station based on at least one criterion; and a paging function to subsequently page the idle mobile station on the assigned one of the N available carriers.

In a still further aspect thereof this invention provides a mobile station operable in a MC wireless network, where the mobile station includes a transceiver and a controller, where the controller is responsive to an order message received from the MC wireless network via the transceiver, when in an idle state, to transition to a carrier identified by the order message and to monitor the carrier for a paging message.

The controller is further operable to execute an idle handoff to one of another carrier, in the same cell or in a target cell, identified by a subsequent order message received over the assigned carrier, or to the same carrier in the target cell.

### BRIEF DESCRIPTION OF THE DRAWINGS

The foregoing and other aspects of the embodiments of this invention are made more evident in the following Detailed Description of the Preferred Embodiments, when read in conjunction with the attached Drawing Figures, wherein:

FIG. 1 is a block diagram of an example of a radio layer protocol stack of a multi-carrier wireless network that is suitable for implementing the teachings of this invention, where in one aspect thereof a Resource Management Function (RMF) in a MAC Layer instructs a MS through upper layer signaling for Circuit Switched (CS) operation and through FPDChCF for Packet Switched (PS) operation;

FIG. 2 is a block diagram of another example of a radio layer protocol stack of a multi-carrier wireless network that is also suitable for use in implementing the teachings of this invention, where in one aspect thereof a RMF in the PHY Layer instructs the MS through upper layer signaling for CS operation and through a FPDChCF for PS operation;

FIG. 3 is a block diagram of the resource management function that forms a part of a carrier selector function shown in FIGS. 1 and 2;

FIG. 4 shows a representative message flow between the MS and a BS when the BS sends an order message to the MS to move to a different carrier in accordance with a first embodiment of this invention; and

FIG. 5 shows a representative message flow between the MS and a BS subsequent to an idle handoff in accordance with another embodiment of this invention, where the MS sends an Acknowledgment message to the BS upon completion of the idle handoff, where the MS is not restricted to camp on the same carrier, and also shows a subsequent dynamic re-assignment of the idle MS to another carrier by the BS.

### DETAILED DESCRIPTION OF THE PREFERRED EMBODIMENTS

Aspects of the embodiments of the invention described below relate to methods and apparatus to page a MS in a multi-carrier wireless network and system. In a presently preferred, but non-limiting embodiment of this invention the multi-carrier system provides flexibility in assigning and re-assigning carriers to the MS. As such, a description will first be provided of presently preferred, but non-limiting, embodiments of a flexible multi-carrier wireless system and network, followed by a description of the presently preferred embodiments of paging methods and apparatus for use in the multi-carrier system and network.

In a presently preferred multi-carrier system, the MS is enabled to use one or more carriers, and the MS is enabled to park in any one of the carriers. An aspect of this invention is thus a method to assign an idle MS to park in an appropriate carrier of a multi-carrier system.

In the presently preferred flexible multi-carrier (MC) wireless network an initial carrier allocation of M carrier(s) is made to the mobile station, where M is less than or equal to a total number of carriers N in the MC wireless network. In the presently preferred, but non-limiting, embodiment of the flexible MC wireless network, the MC wireless network is capable of subsequently re-allocating carriers to the mobile station by at least one of changing the value of M based on at least one criterion and moving the mobile station to at least one other carrier.

Ideally, when idle the MS should be able to park on any one of the carriers. However, parking all idle MSs on a single designated carrier may overwhelm the access channel, as the potential then exists for too many MSs to use the access channel simultaneously, e.g., to originate a call, to respond to a call, or to perform some mobility procedure. In addition, since many applications only require a single carrier, such as voice service, the single carrier may become saturated unless the network moves the MS to another carrier before the service is initiated. However, this will increase the latency.

As may be appreciated, parking idle MSs in different carriers requires the MC wireless network to potentially page a particular MS in all of the carriers, if the network does not have knowledge of the carrier on which the MS has parked.

The presently preferred embodiments of this invention address and resolve these and other potential problems that arise with regard to paging a MS in a multi-carrier system.

In commonly assigned U.S. patent application Ser. No. 10/______, filed on even date herewith and entitled “Method and Apparatus to Optimize the Utilization of the Carriers in a Flexible Multi-Carrier System”, by Rene Pumadi, Haihong Zheng, Naveen Kakani and Adrian Boariu, there are described methods and apparatus to provide flexible assignment of one or more carriers when the mobile station is in an active state, and is at least one of transmitting and receiving traffic. The presently preferred embodiments of this invention are more concerned instead with idle state operation and control of the mobile station. It should thus be appreciated that while the embodiments of this invention may be employed with the flexible multi-carrier system described in the above-captioned commonly assigned U.S. Patent Application, which is incorporated by reference herein in its entirety, the embodiments of this invention may also be employed to advantage in other types of multi-carrier systems, including those conventional types of systems that do not provide for flexible active state multi-carrier selection and assignment.

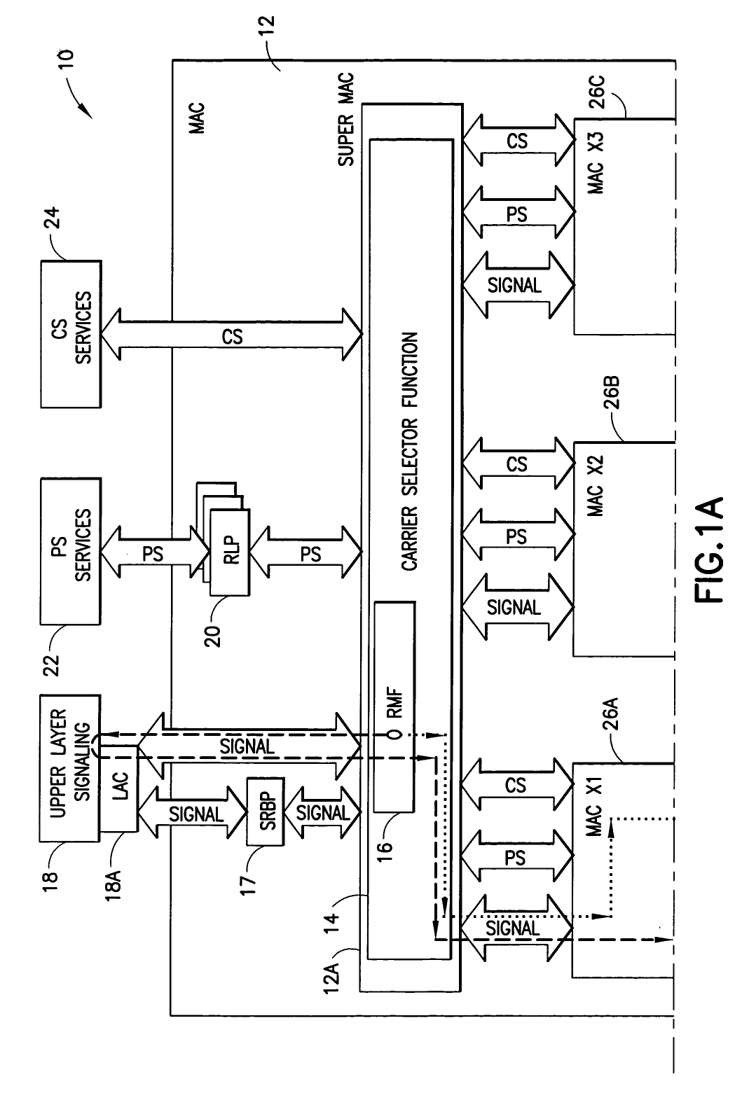

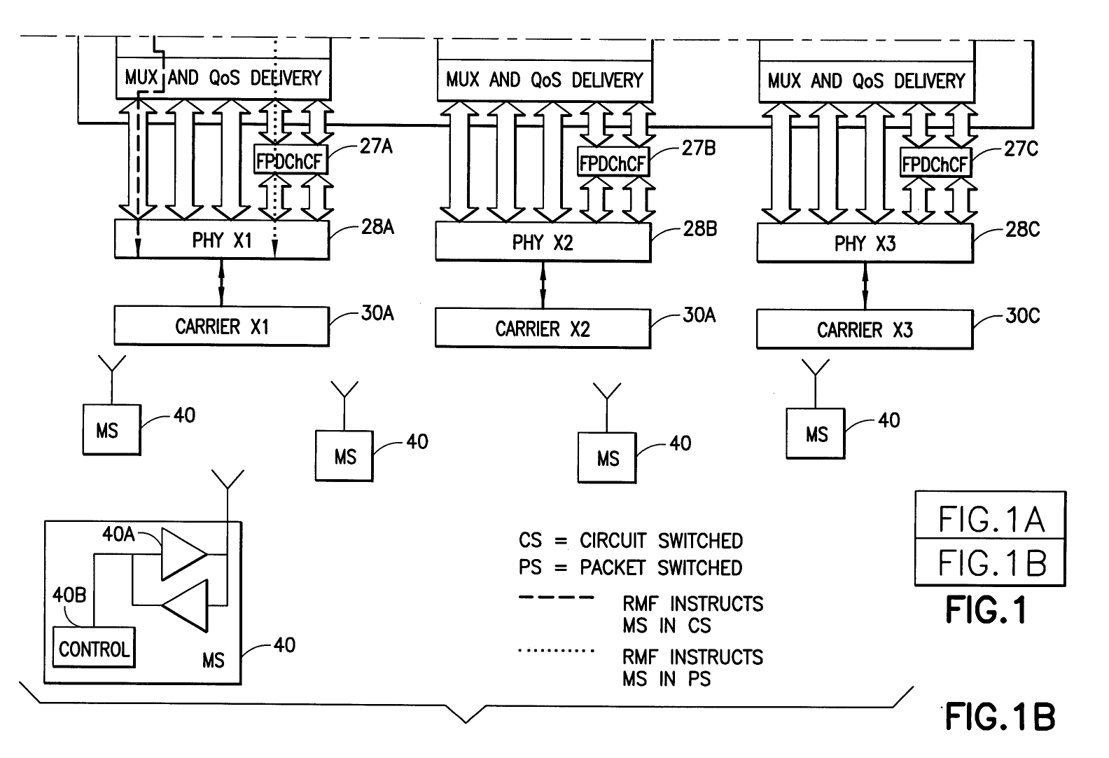

FIG. 1 is a block diagram of an example of a radio layer protocol stack 10 that is associated a MC wireless system or network, that is constructed and operated in accordance with the above-captioned commonly assigned U.S. Patent Application. A Medium Access Control (MAC) layer 12 includes a carrier selector function (CSF) 14 that includes a Resource Management Function (RMF) 16 that operates in accordance with the embodiments of this invention. An upper layer signaling block 18 is directly coupled to the MAC 12, or is indirectly coupled via a SRBP (Signaling Radio Burst Protocol) block 17 and with a LAC (Link Access Control) 18A. Also coupled to the MAC 12 via a plurality of Radio Link Protocol (RLP) blocks 20 is a Packet Switched (PS) services function 22. Also coupled to the MAC 12 is a Circuit Switched (CS) services function 24. Each of the three carriers has an associated MAC function (X1, X2, X3) 26A, 26B and 26C each having an associated multiplexing (MUX) and Quality of Service (QoS) functionality, and each MAC function 26A, 26B, 26C has associated signaling, PS and CS inputs and outputs that are interfaced to the upper layer signaling function, 18, the PS service 22 and the CS services 24 via the intervening carrier selector function 14. Each MAC function 26A, 26B, 26C is associated with a corresponding physical (PHY) layer (X1, X2, X3) 28A, 28B and 28C, and with one of the three carriers (X1, X2, X3) 30A, 30B, 30C, collectively referred to as carriers 30, of the MC radio layer protocol stack 10. Each of the carriers 30 can convey a plurality of radio channels. The signaling portion of the interface between MACs 26A, 26B, 26C and the PHYs 28A, 28B, 28C is conveyed through a Forward Packet Data Control Channel (FPDCCH) that includes a Forward Packet Data Channel Control Function (FPDChCF), designated as 27A, 27B and 27C.

Also shown in FIG. 1 are a plurality of mobile stations (MS) 40 that are bidirectionally coupled to the carriers 30A, 30B, 30C for receiving packet switched and/or circuit switched services. The various MS 40 can include, but are not limited to, cellular telephones, personal digital assistants (PDAs), portable computers, image capture devices such as digital cameras, gaming devices, music storage and playback appliances, Internet appliances permitting Internet access and browsing, as well as portable units or terminals that incorporate combinations of such functions. Each MS 40 is assumed to include at least a wireless transceiver 40A that is MC compatible, and a controller 40B operable to receive and respond to messages from the protocol stack 10 of the MC wireless network.

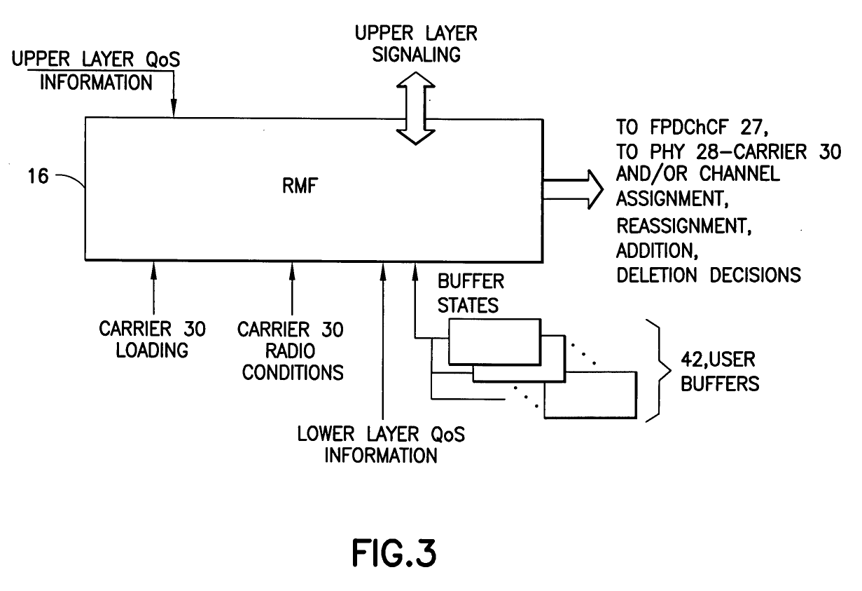

In the above-captioned commonly assigned U.S. Patent Application there are described procedures to optimize the use of the carriers 30 by dynamically assigning downlink traffic to one or more of the carriers 30. Certain system parameters, such as load condition and the radio condition in a carrier, a user buffer 42 (see FIG. 3) condition (e.g., empty, full, nearly empty, nearly full, half full, etc.), and updated QoS requirements, may trigger the RMF 16 in the MC wireless network 10 to modify the assigned carriers 30 by moving a particular user's MS 40 to another carrier, and/or to add or eliminate carrier(s) being used by a particular MS 40.

In a non-limiting embodiment an active state MS 40 can be setup to use one or more carriers 30 when receiving data, depending on the required QoS. Typically, more stringent QoS requirements (e.g., higher throughput, lower delay, etc.) will result in more than one of the carriers 30 being assigned to the MS 40. Various non-limiting QoS requirements that may be monitored by the RMF 16 include bandwidth, delay and loss rate. For example, a CS voice call may be serviced by one carrier, while a video streaming service may be serviced by two or three carriers.

At least a portion of the protocol stack 10 of the MC wireless network monitors certain system parameters. As non-limiting examples, the protocol stack 10, in particular the RMF 16, monitors the load condition and the radio condition in each of the carriers 30, the level or state of buffers 42 associated with the various MSs 40, and an occurrence of updated and revised QoS requirements. For example, an occurrence of an unbalanced load condition between individual ones of the carriers 30, and/or a bad radio condition in a particular one of the carriers 30, triggers the RMF 16 to re-assign a MC-capable one of the MSs 40 to other carrier(s) 30. For example, a MS 40 network buffer 42 that exceeds an upper/lower threshold, or an occurrence of an updated QoS parameter, is capable of triggering the RMF 16 not only to add or eliminate (supplemental) channel(s) within one of the carriers 30, but also to add or eliminate radio channel(s) in different carrier(s) 30, if desired.

In the above-captioned commonly assigned U.S. Patent Application the RMF 16 monitors certain MC wireless system parameters. Once the RMF 16 detects a need to re-assign and/or to modify the carrier assignment, the RMF 16 sends a carrier modification indication, for a packet switched session, to the FPDChCF 27 in a current (source) carrier over the FPDCCH. For a circuit switched session the RMF 16 instead sends the carrier modification indication to Layer 3 (L3), part of upper layer signaling block 18, to directly send a L3 message either through the f-dsch (forward dedicated signaling channel), or multiplexed in a fundamental f-dtch (forward dedicated traffic channel), to signal the MS to move to other carrier(s) 30, and/or to add or to eliminate carrier(s) 30. The message from the RMF 16 to the FPDChCF 27 contains parameters that are interpreted by the FPDChCF 27 and forwarded to the MS 40. The message from the RMF 16 to the L3 contains parameters interpreted by L3, part of upper layer signaling 18, and forwarded to the MS 40.

If each one of the carriers 30 has an independent FPDChCF 27, as shown in the embodiment of FIG. 1, the RMF 16 also sends a (second) message to the FPDChCF in the destination (target) carrier(s) 30 to instruct the target FPDChCF 27 to prepare the appropriate radio resources in the target carrier. If the multiple carriers 30 are instead controlled by a single FPDChCF 27, the same FPDChCF 27 prepares the appropriate radio resources in the target carrier(s) 30, and the use of the subsequent message may not be required.

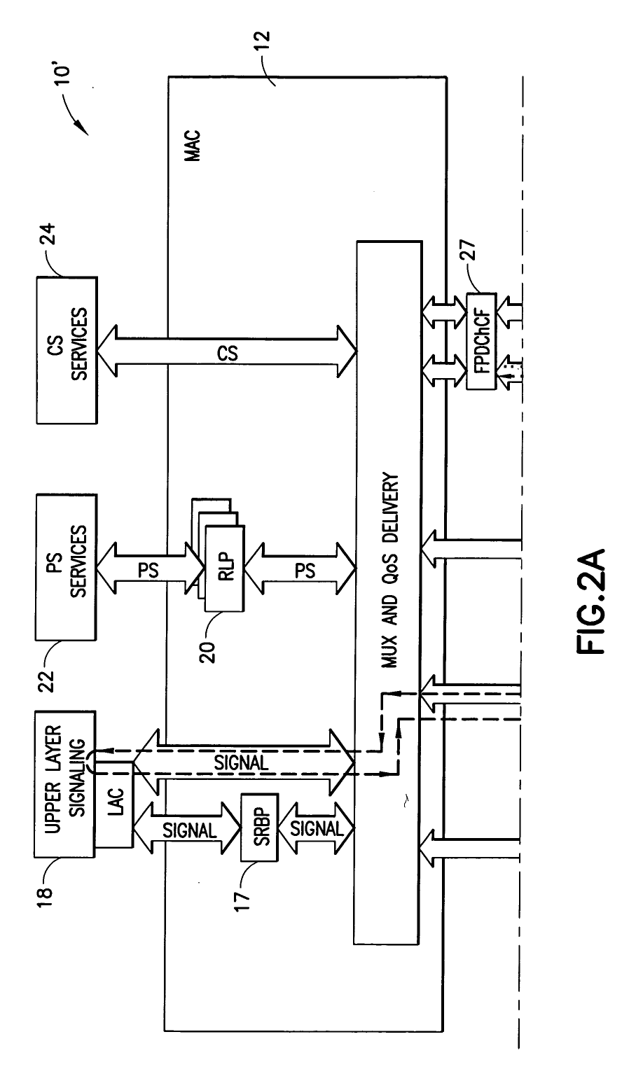

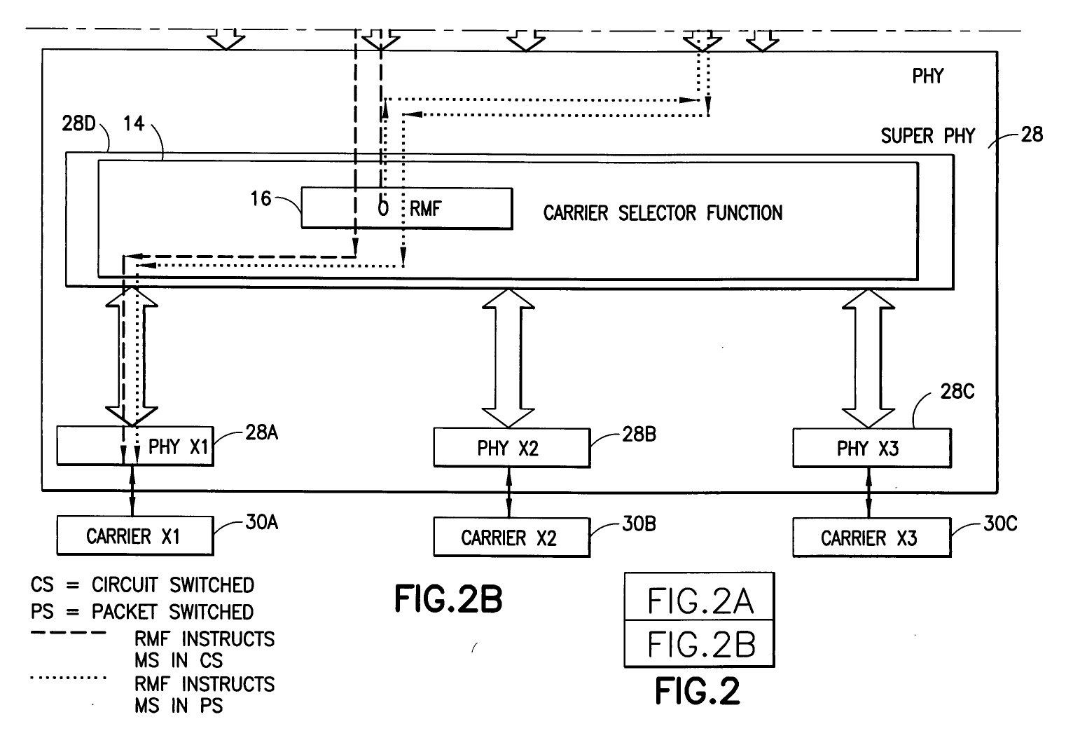

In the above-captioned commonly assigned U.S. Patent Application there are described two exemplary embodiments for implementing the flexible multi-carrier system. The first embodiment is based on the carrier selector function 14 in the cdma2000 MAC layer 12, as shown in FIG. 1, while the second embodiment is based on placing the carrier selector function 14 in the physical layer 28, and is shown in FIG. 2 and discussed further below.

In the first embodiment, and as was already at least partially discussed, the RMF 16 is located in MAC layer 12, adjacent to the carrier selector function 14. The lower (sub)layer(s) 26, 28 continuously send carrier-related information, for example the load conditions in each of the carriers 30, the radio conditions in each of the carriers 30, and the MAC PDU (Packet Data Unit) buffer 42 of each QoS category for a user, to the RMF 16. The upper layer 18 may also send, for example, modified or updated QoS information to the RMF 16 (note that the layers 22 and 24 contain payload, and not signaling per se). The receipt of this information may trigger the RMF 16 to move a particular MS 40 to a different carrier(s), and/or to add or to eliminate one or multiple carriers 30. The RMF 16 instructs the MS 40 to use different carriers, and/or to add or to eliminate one or multiple carriers 30 through the upper layer (L3) signaling entity for a CS session or through the FPDChCF 27 for a PS session, as shown in FIG. 1. As was noted above, the upper layer signaling entity sends the instruction through f-dsch or multiplexed in the fundamental f-dtch to the MS 40, while the FPDChCF 27 sends the instruction through the F-PDCCH to the MS 40.

The RMF 16 may also indicate to the upper layer signaling entity and/or the target FPDChCF 27 to instruct the (target) carrier(s) to prepare or release resources for the MS 40.

Referring to FIG. 2, in the second embodiment disclosed in the above-captioned commonly assigned U.S. Patent Application the MC radio layer protocol stack 10′ the RMF 16 is located in PHY layer 28, adjacent to the carrier selector function 14 that is also located in PHY. As in the embodiment of FIG. 1, the lower (sub)layer(s) 28 continuously send carrier-related information, for example the load conditions in each of the carriers 30, the radio conditions in each of the carriers 30, and the radio frame buffer 42′ for a user, to the RMF 16. It may be noted that in this embodiment the buffer is the radio frame buffer, which does not recognize the QoS Category since the scheduling is performed in the MAC 12. The upper layer 18 may also send, for example, modified or updated QoS information to the RMF 16. The receipt of this information may trigger the RMF 16 to move a particular MS 40 to a different carrier(s), and/or to add or to eliminate one or multiple carriers 30. The RMF 16 instructs the MS 40 to use different carriers, and/or to add or to eliminate one or multiple carriers 30 through the upper layer (L3) signaling entity for a CS session or through the (single instance in this case) FPDChCF 27 for a PS session, as shown in FIG. 2. As was noted previously, the upper layer signaling entity sends the instruction through f-dsch or multiplexed in the fundamental f-dtch to the MS 40, while the FPDChCF 27 sends the instruction through the F-PDCCH to the MS 40. As in the embodiment of FIG. 1, the RMF 16 may also indicate to the upper layer signaling entity and/or the target FPDChCF 27 to instruct the (target) carrier(s) to prepare or release resources for the MS 40. In the presently preferred, but non-limiting embodiments there is one FPDChCF 27 per carrier.

The embodiments described in the above-captioned commonly assigned U.S. Patent Application enable the forward link transmission of user data over M sub-carriers in an N sub-carrier system, where M≦N. Without restricting the generality, N=3 and the network can be referred to as a 3× network or system. For example, in the cdma2000 MC system the user data can be transmitted over one, two or three sub-carrier(s) 30, as opposed to being evenly spread over all three sub-carriers 30. The entity that determines the number of sub-carrier(s) and which sub-carrier(s) to be used is termed the carrier selector function (CSF) 14, and it contains as an element thereof the RMF 16.

Having thus described non-limiting embodiments of MC wireless networks 10, 10′ that are suitable environments within which to implement the paging-related aspects of the present invention, a more detailed description of the preferred embodiments of the present invention is now provided.

The embodiments of this invention provide techniques to assign an idle MS 40 to a certain carrier, and preferably to also keep track of (maintain a record that is descriptive of) which carrier the MS 40 is assigned to (and camped on).

In accordance with the embodiments of this invention the MS 40 employs the transceiver 40A and the controller 40B to receive an order message over a carrier to move to another carrier on which to camp to receive paging messages, to perform idle handoffs to the same or to a different carrier in the same or a different paging area, and to optionally inform the protocol stack, such as the protocol stack 10, 10′ of the MC wireless network of the identification of a new carrier on which the MS 40 is to receive paging messages, as described in greater detail below.

In a first embodiment, an idle MS 40 is assigned a carrier based on a certain parameter, for example a unique MS 40 identifier such as the IMSI (International Mobile Subscriber Identifier), where a certain portion of the IMSI is assigned to or associated with a certain carrier. Assuming a population of MSs 40 have randomly spread IMSIs (or other unique or semi-unique identifiers), the result is to substantially uniformly spread the population of MSs 40 over the available carriers.

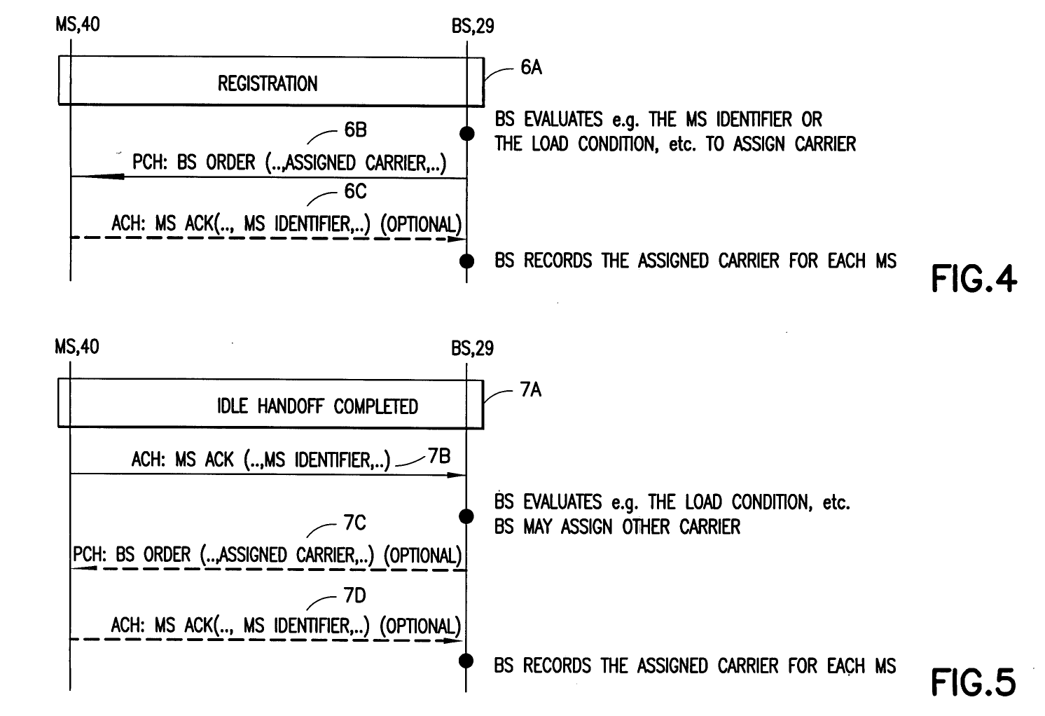

Referring also to FIG. 4, when the MS 40 acquires the wireless network, and after performing the necessary registration (operation 6A), the network via a base station (BS) 29, assigns a carrier to the MS 40 and, if necessary, instructs the MS 40, such as through a paging channel (PCH), to camp on the assigned carrier (operation 6B). In this case the network does not have to keep track of the carrier where the idle MS 40 is located, as the MS40 identifier (e.g., the IMSI) itself identifies the carrier where the MS 40 is camped.

In a second embodiment, the network dynamically assigns a carrier based on the load condition of each carrier, and keeps track of the carrier where the idle MS 40 is camped. When the MS 40 acquires the network, and after performing the necessary registration, the network assigns a carrier to the MS 40 and, if necessary, instructs the MS 40, such as through the PCH, to camp on the assigned carrier. The network maintains a record of the carrier on which the MS 40 is camped, and the record indicates the assigned carrier along with a paging area identifier. The idle MS 40 may be re-assigned to a different carrier when necessary, and the network instructs the MS 40 to move to the different carrier. The above-described RMF 16 can participate in this embodiment, such as by selecting a carrier based on loading and/or other criteria.

It is noted in this regard that the QoS input(s) may be ignored by the RMF 16, as the QoS parameter(s) are typically associated with active states MSs, not idle state MSs.

In either case the MS 40 optionally may respond with an Acknowledgment message (operation 6C) that may include the MS identifier.

A third embodiment is similar to the second embodiment, except that the network does not maintain the record of which carrier the idle MS 40 is currently camped on. Instead, the network pages the MS 40 on all available carriers 30.

Referring now also to FIG. 5, when the idle MS 40 performs an idle handoff (operation 7A), the network requires knowledge of which carrier the MS 40 is camped on (in the target BS 29).. In the first paging embodiment described above, the MS 40 is restricted to handoff only to the same carrier as the currently assigned carrier, since it is assigned based on at least one particular parameter such as the MS 40 unique identifier. In this case the idle handoff procedure can be similar to the currently used and conventional idle handoff procedure.

In the second embodiment there are at least two idle handoff options. In a first option the MS 40 is restricted to handoff to the same carrier within the same paging area. In this case, the procedure can be similar to the currently used and conventional idle handoff procedure. The change in a certain carrier's loading condition within one paging area, however, may trigger the network to page a particular MS 40 or several MSs 40 on the currently assigned carrier with instructions to move to a different (less heavily loaded) carrier (operation 7C), to which the MS 40 may respond with an Acknowledgment message (operation 7D). The second option permits the idle MS 40 to camp on any carrier, based on the preferred CDMA channel list or on a strongest signal/pilot signal strength. In the event the idle MS 40 changes the carrier, it uses the access channel to report to the network the occurrence of the idle handoff, as well as the identification of the acquired carrier (whether the carrier was changed or was not changed, as in operation 7B). The network records the identification of the carrier where the MS 40 has camped and, if necessary, the network can instruct the MS 40 to move to another carrier due to carrier loading and/or other parameters (operation 7C). This second embodiment preferably has the MS 40 wake up when it changes the carrier in the target cell and/or the network orders the MS 40 to change the carrier in the target cell.

In the third embodiment the idle MS 40 is allowed to change its carrier during the idle handoff. Since the network does not record the carrier where the idle MS 40 camps, the MS 40 is not required to report to the network when the idle MS 40 changes carriers in the target cell, since this embodiment expects that the network will page the MS 40 in all carriers.

In the preferred embodiments, when the MS 40 completes the registration procedure after powering up and camping on a carrier, the MS 40 begins listening to the paging channel that is conveyed through the carrier. The network, after evaluating at least one parameter, such as a MS 40 identifier or the load condition in each carrier within the paging area, may send an order message via the paging channel that requests the MS 40 to move to a different carrier. For the first and the second embodiments the network maintains a record of the carrier (and the associated paging area) of each idle MS 40. In the third embodiment the network need only record the paging area, as it pages the MS 40 on all carriers within the paging area.

For the case where the carrier is assigned in whole or in part based on the carrier loading conditions, a change in the load conditions may prompt the network to send an order message via the paging channel to the idle MS(s) 40 to change carriers (operations 6B and 7C). For the case where the assigned carrier is based on the MS 40 identifier, the network preferably does not order the MS 40 to change carriers after the MS 40 acquires the appropriate carrier.

Any order message sent to the MS 40 in operations 6B and/or 7C to change carriers includes information that is descriptive of the destination (target) carrier, for example, the CDMA channel number.

In the idle handoff case (FIG. 5), the MS 40 is restricted to handoff either to the same carrier or to any carrier in the target cell. If the MS 40 is restricted during idle handoff to the same carrier, the procedure is similar to the conventional procedure. In the case where the MS 40 acquires a different carrier in the target cell, either the MS 40 must send an Acknowledgment message (operation 7B), via the access channel (ACH), to inform the network 40 of the identification of the new carrier so that the network can record the carrier with which the MS 40 is newly associated, or no Acknowledgment is sent to the network and the network subsequently pages the MS 40 over all carriers.

In the preferred embodiments of this invention there is provided an ability to assign a carrier to an idle MS 40 based on, as non-limiting examples, at least one parameter such as a MS 40 identifier, or a load condition in available carrier(s). To accomplish this it may be desirable to define a new order message from the BS 29 to the MS 40 to order the MS 40 to move to a different carrier. If the MS 40 acquires the carrier in a target cell based on a preferred CDMA channel, it may be desirable to define a new Acknowledgment message from the MS 40 to the BS 29 to be sent on the completion of the idle handoff.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent messaging formats and/or upper and/or lower layer signaling mechanisms may be attempted by those skilled in the art. Further, and as was noted previously, the use of the flexible MC system as described in the commonly assigned U.S. Patent Application referenced above is not a requirement of, or limitation upon, the practice of the preferred embodiments of this invention.

Thus, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

What is claimed is:

1. In a multi-carrier (MC) wireless network, a method to allocate a carrier to an idle mobile station, comprising:
in response to the mobile station registering with the MC wireless network, selecting one of N available carriers to be assigned to the idle mobile station based on at least one criterion; and
subsequently paging the idle mobile station on the assigned one of the N available carriers.

2. A method as in claim 1, where the at least one criterion comprises an identification of the mobile station.

3. A method as in claim 1, where the at least one criterion comprises an amount of loading of individual ones of the N available carriers.

4. A method as in claim 1, further comprising subsequently assigning a different carrier to the idle mobile station based on at least one re-assignment criterion.

5. A method as in claim 4, where the at least one re-assignment criterion comprises an amount of loading of individual ones of the N available carriers.

6. A method as in claim 1, where paging occurs via a paging channel of the assigned carrier.

7. A method as in claim 4, where re-assigning a different carrier comprises paging the mobile station via a paging channel of the currently-assigned carrier.

8. A method as in claim 1, further comprising sending an acknowledgment message from the mobile station to the MC wireless network.

9. A method as in claim 8, where the acknowledgment message is sent via an access channel of the currently-assigned carrier.

10. A method as in claim 1, further comprising performing an idle handoff of the mobile station from the assigned one of the N available carriers to the same carrier in a target cell.

11. A method as in claim 1, further comprising performing an idle handoff of the mobile station from the assigned one of the N available carriers to a different carrier in a target cell.

12. A method as in claim 11, further comprising the mobile station informing the MC wireless network of an identity of the different carrier.

13. A method as in claim 1 wherein subsequently paging the idle mobile station on the assigned one of the N available carriers comprises paging the idle mobile station on each of the N available carriers.

14. A multi-carrier (MC) wireless network, comprising a carrier allocation function to allocate a carrier to an idle mobile station comprising a carrier selector, responsive to the mobile station registering with the MC wireless network, to select one of N available carriers to be assigned to the idle mobile station based on at least one criterion; and a paging function to subsequently page the idle mobile station on the assigned one of the N available carriers.

15. A MC wireless network as in claim 14, where the at least one criterion comprises an identification of the mobile station.

16. A MC wireless network as in claim 14, where the at least one criterion comprises an amount of loading of individual ones of the N available carriers.

17. A MC wireless network as in claim 14, where said carrier selector is operative to subsequently assign a different carrier to the idle mobile station based on at least one re-assignment criterion.

18. A MC wireless network as in claim 17, where the at least one re-assignment criterion comprises an amount of loading of individual ones of the N available carriers.

19. A MC wireless network as in claim 14, where said paging function uses an order message sent over the paging channel of the assigned carrier.

20. A MC wireless network as in claim 17, where said paging function uses an order message sent over the paging channel of the currently-assigned carrier.

21. A MC wireless network as in claim 14, where said mobile station comprises a controller for sending an acknowledgment message to the MC wireless network.

22. A MC wireless network as in claim 21, where the acknowledgment message is sent via an access channel of the currently-assigned carrier.

23. A MC wireless network as in claim 14, where said mobile station comprises a controller and a transceiver operable to perform an idle handoff of the mobile station from the assigned one of the N available carriers to the same carrier in a target cell.

24. A MC wireless network as in claim 23, where said controller is further operable to execute an idle handoff to another carrier, in a target cell, that is identified by a subsequent order message received over the assigned carrier.

25. A MC wireless network as in claim 14, where said mobile station comprises a controller and a transceiver operable to perform an idle handoff of the mobile station from the assigned one of the N available carriers to a different carrier in a target cell.

26. A MC wireless network as in claim 25, where said controller is further operable to inform the MC wireless network of an identity of the different carrier.

27. A MC wireless network as in claim 14, wherein the paging function is to subsequently page the idle mobile station on each of the N available carriers.

28. A mobile station operable in a multi-carrier (MC) wireless network and comprising a transceiver and a controller, said controller being responsive to an order message received from the MC wireless network via the-transceiver when in an idle state to transition to a carrier identified by the order message and to monitor the paging message in the assigned carrier.

29. A mobile station as in claim 28, where said controller is further operable to send an acknowledgment message to the MC wireless network 30. A mobile station as in claim 28, where said controller is further operable to execute an idle handoff to another carrier, in a target cell, identified by a subsequent order message received over the assigned carrier, or to the same carrier in the target cell.
